(19) United States
(12) Patent Application Publication
(10) Pub. No.: US 2023/0182905 A1
(43) Pub. Date: Jun. 15, 2023

(54) RAM AIR CONTROL SYSTEMS AND METHODS

(71) Applicant: THE BOEING COMPANY, CHICAGO, IL (US)

(72) Inventors: Warren A. Atkey, Bothell, WA (US); Gene Stubbs, Seattle, WA (US)

(73) Assignee: THE BOEING COMPANY, CHICAGO, IL (US)

(21) Appl. No.: 17/548,702

(22) Filed: Dec. 13, 2021

(51) Int. Cl. B64D 13/02

(52) U.S. Cl. CPC B64D 13/02; B64D 2013/0603

(57) ABSTRACT

A ram air system includes a ram air inlet, a ram air outlet, a conduit fluidly coupling the ram air inlet to the ram air outlet, and a relief port disposed within the conduit. A method of controlling a ram air system includes disposing a relief port within a conduit of the ram air system, wherein the conduit fluidly couples a ram air inlet to a ram air outlet in order to minimize or otherwise reduce drag, and to control unstable airflow that can otherwise cause resonant instability.

### FIELD OF THE DISCLOSURE

Examples of the present disclosure generally relate to systems and methods for controlling ram air systems, such as can be used within aircraft.

### BACKGROUND OF THE DISCLOSURE

Ram air systems are used with certain aircraft. For example, a commercial aircraft includes an environmental control system (ECS) in fluid communication with a ram air system. The ram air system includes an air inlet and an air outlet or exit.

In order to minimize or otherwise reduce drag and to control unstable airflow that can otherwise cause resonant instability, the ram air system typically includes a first modulator (such as a moveable door) proximate to the air inlet, and a second modulator (such as a moveable door or louvers) proximate to the air outlet. Modulation of air flow at the air outlet provides thrust recovery, while the modulation of air flow at the air inlet reduces resonant instability and reduces inlet spillage drag.

As can be appreciated, multiple modulators within a ram air system add weight and complexity to the ram air system. The use of multiple modulators increases the number of parts to procure, install, and maintain, thereby adding weight and cost (both in terms of material and labor).

### SUMMARY OF THE DISCLOSURE

A need exists for a ram air system that is configured to control resonant instability (that is, reducing resonant instability). Further, a need exists for an efficient and effective system and method for controlling a ram air system. Additionally, a need exists for a simpler and less costly system and method for controlling resonant energy within a ram air system.

With those needs in mind, certain examples of the present disclosure provide a ram air system including a ram air inlet, a ram air outlet, a conduit fluidly coupling the ram air inlet to the ram air outlet, and a relief port disposed within the conduit.

In at least one example, the ram air system also includes a modulator proximate to the ram air outlet. As a further example, the ram air system is devoid of an additional modulator.

In at least one example, the ram air system also includes an environmental control system (ECS) disposed within the conduit between the ram air inlet and the ram air outlet. As a further example, the relief port is disposed within the conduit between the ram air inlet and the ECS.

In at least one example, the relief port includes a valve.

In at least one example, the ram air system is disposed within an aircraft. As a further example, the ram air system is disposed within a wing-to-body fairing of the aircraft.

In at least one example, the relief port includes an air inlet formed in the conduit, and a duct in fluid communication with the air inlet. The duct includes an air outlet.

In at least one example, the relief port is closer to the ram air inlet than the ram air outlet.

In at least one example, the relief port has a first span, and the ram air inlet has a second span. As an example, the first span is 5% or less than the second span.

Certain examples of the present disclosure provide a method of controlling a ram air system, the method including disposing a relief port within a conduit of the ram air system, wherein the conduit fluidly couples a ram air inlet to a ram air outlet.

Certain examples of the present disclosure provide an aircraft including a wing-to-body fairing, and a ram air system including an environmental control system (ECS) within the wing-to-body fairing, as described herein.

### BRIEF DESCRIPTION OF THE DRAWINGS

FIG. 1 illustrates a perspective front view of an aircraft, according to an example of the present disclosure.

FIG. 2 illustrates a lateral internal view of a ram air system, according to an example of the present disclosure.

FIG. 3 illustrates a lateral internal view of a ram air system, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and methods for controlling a ram air system, such as to control or otherwise reduce resonant instability. In at least one example, the systems and methods are configured to modulate only one end of the ram air pathway and achieve acceptable overall performance, and thereby provide a simpler, less costly overall system. In at least one example, the systems and methods eliminate, minimize, or otherwise reduce a need to modulate airflow at both ends of a ram air pathway. In at least one example, a relief port is formed in a ram air conduit (for example, an air duct). As a further example, a surge valve can be disposed within the relied port. By disposing the relief port in the ram air conduit, the need for a modulator, such as proximate to the air inlet, is eliminated or otherwise reduced. In at least one example, a system and a method for controlling a ram air system maintains stable, efficient operation of the ram air system without modulation at or otherwise proximate to an air inlet.

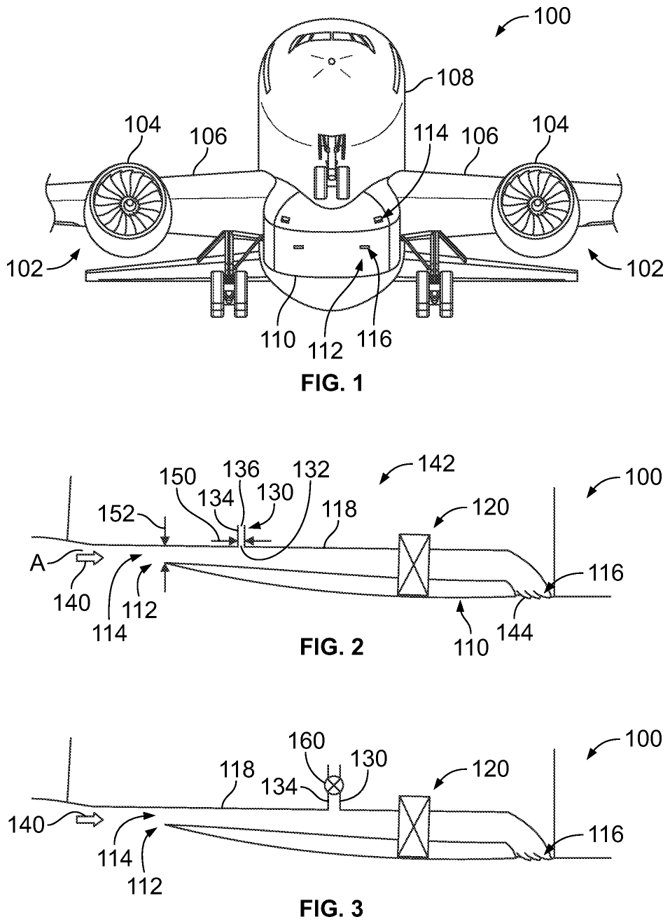

FIG. 1 illustrates a perspective front view of an aircraft 100, according to an example of the present disclosure. The aircraft 100 includes a propulsion system 102 that includes engines 104, for example. Optionally, the propulsion system 102 may include more engines 104 than shown. The engines 104 are carried by wings 106 of the aircraft 100. In other examples, the engines 104 may be carried by a fuselage 108 and/or an empennage. The empennage may also support horizontal stabilizers and a vertical stabilizer.

A wing-to-body fairing 110 extends from a lower portion of the fuselage 108. The wing-to-body fairing 110 is disposed between and below the wings 106. At least a portion of an environmental control system (ECS) can be disposed within the wing-to-body fairing 110. The ECS is in communication with a ram air system 112, which includes a ram air inlet 114 and a ram air outlet 116. For example, the ram air system 112 includes the ECS. The ram air inlet 114 is upstream from the ram air outlet 116. As such, the ram air inlet 114 is configured to receive air, which passes through the ram air system 112, and exits through the ram air outlet 116.

In at least one example, the ram air system 112 is configured to expel waste heat from one or more systems. The ram air system 112 can be configured to expel waste heat from the ECS. In at least one other example, the ram air system 112 can be configured to expel waste heat from systems other than an ECS.

Optionally, the ram air system 112 can be disposed within different portions of the aircraft 100. For example, the ram air system 112 can be disposed within other portions of the fuselage 108, and be in communication with the ECS or another system within the aircraft. As a further example, the ram air system 112 can be disposed within a portion of a wing 106, an engine 104, and/or the like.

Alternatively, instead of an aircraft, examples of the present disclosure may be used with various other vehicles, such as automobiles, buses, locomotives and train cars, watercraft, and the like.

FIG. 2 illustrates a lateral internal view of the ram air system 112, according to an example of the present disclosure. In at least one example, the ram air system 112 is within the wing-to-body fairing 110. Optionally, the ram air system 112 can be disposed within various other portions of the aircraft 100 or other such vehicle.

The ram air system 112 includes the ram air inlet 114, which can be or otherwise include an opening formed in a portion of the wing-to-body fairing 110. The ram air inlet 114 is in fluid communication with (and/or forms an opening within) a conduit 118 (such as an air duct). In at least one example, at least a portion of an ECS 120 is disposed within the conduit 118. The ECS 120 can include a pack heat exchanger, one or more plenums, an air cycle machine, and/or the like. The ECS 120 is disposed between the ram air inlet 114 and the ram air outlet 116.

In order to control resonant energy within the ram air system 112, a relief port 130 is disposed within the conduit 118. The relief port 130 includes an air inlet 132 (such as an opening) formed in the conduit 118. The air inlet 132 formed within the conduit 118 provides an opening for air to pass. The relief port 130 can also include a duct 134 in fluid communication with the air inlet 132. The duct 134 further includes an air outlet 136. As such, at least a portion of ram air 140 that passes into the conduit 118 through the ram air inlet 114 passes into the relief port 130 through the air inlet 132, and passes into a cavity 142, such as within the wing-to-body fairing 110, via the air outlet 136. Optionally, the relief port 130 can be an opening, such as a hole, formed in the conduit 118.

As noted, a portion of the ram air 140 can pass into the relief port 130 and be discharged into the cavity 142. In at least one other example, the relief port 130 can be is fluid communication with a relief outlet formed in an outer portion of the wing-to-body fairing 110. As such, the portion of the ram air 140 that passes into the relief port 130 can be discharged out of the aircraft 100.

In at least one example, the ram air system 112 further includes a modulator 144 such as within or proximate to the ram air outlet 116. The modulator 144 can be one or more moveable doors, louvers, and/or the like. As shown, in at least one example, the ram air system 112 includes only one modulator, such as the modulator 144 at or proximate to the ram air outlet 116. The ram air system 112 is devoid of another (for example, second) modulator upstream from the modulator 144. It has been found that the relief port 130 and the modulator 144 effectively reduce drag and control resonant energy within the ram air system 112 without the use of an additional modulator. The relief port 130 provides an opening or hole within the conduit 118 (or header) that dissipates resonant energy and prevents or otherwise reduces resonant instability.

The terms upstream and downstream are in relation to the direction of airflow A. That is, the ram air 140 flows from the ram air inlet 114 toward and out of the ram air outlet 116. The ram air inlet 114 is upstream from the ram air outlet 116. An item that is closer to the ram air inlet 114 is upstream from an item that is closer to the ram air outlet 116. Conversely, an item that is closer to the ram air outlet 116 is downstream from an item that is closer to the ram air inlet 114. As shown in FIG. 2, the relief port 130 is upstream from the ECS 120. Conversely, the ECS 120 is downstream from the relief port 130.

As shown, the relief port 130 is disposed with the conduit 118 closer to the ram air inlet 114 than the ram air outlet 116. The relief port 130 is downstream from the ram air inlet 114. The relief port 130 is disposed upstream from the ECS 120. Optionally, the relief port 130 can be disposed closer to the ECS 120 than shown. As another option, the relief port 130 can be disposed closer to the ram air outlet 116 than the ram air inlet 114. In at least one example, the ram air system 112 can include more than one relief port 130.

A span 150 (such as a diameter or width) of the relief port 130 is less than a span 152 of the ram air inlet 114. As an example, the span 150 is less than half the span 152. As a further example, the span 150 is 5% or less than the span 152. As a further example, the span is 1% or less of the span 152. Increasing the size of the span 150 reduces resonant instability, while potentially increasing drag. As such, the span 150 can be sized and shaped to provide an optimal balance between resonant instability reduction and drag reduction.

FIG. 3 illustrates a lateral internal view of the ram air system 112, according to an example of the present disclosure. In at least one example, a valve 160 is disposed within the relief port 130. For example, the valve 160 is disposed within the duct 134 of the relief port 130. In at least one example, the valve 160 is a surge valve, which is less complex than an inlet door, linkage, or actuator. The valve 160 can be a shutoff valve (for example, a valve moveable between an open and closed position), a modulating valve that allows for numerous different positions, or the like.

In at least one example, the valve 160 is configured to open based on parameters such as altitude, speed, position of the modulator 144, measured airflow, and/or the like. A sufficient margin can be chosen between a surge valve opening point and an onset of resonant instability, similar to how surge is managed for centrifugal compressors. In at least one example, the valve 160 is configured to open during atypical and likely limited duration flight conditions (specifically, conditions of relatively high heating demand and/or extreme cold ambient conditions where the modulator 144 is slightly opened).

Referring to FIGS. 1-3, examples of the present disclosure provide the ram air system 112 having the relief port 130 formed within the conduit 118. The relief port 130, such as in conjunction with the modulator 144, reduces resonant instability within the ram air system 112 while causing little to no additional drag. Under typical operating conditions of the ECS 120 (for example), any drag that may be caused by the relief port 130 is minimal or non-existent.

The ram air system 112 includes the ram air inlet 114, the ram air outlet 116, the conduit 118 fluidly coupling the ram air inlet 114 to the ram air outlet 116, and the relief port 130 disposed within the conduit 118. In at least one example, the ram air system 112 also includes the modulator 144, such as proximate to the ram air outlet 116. In at least one further example, the ram air system 112 is devoid of an additional modulator. The ECS 120 can be disposed within the conduit 118 between the ram air inlet 114 and the ram air outlet 116. In at least one example, the relief port 130 is disposed within the conduit 118 between the ram air inlet 114 and the ECS 120. In at least one example, the relief port 130 includes the valve 160. The ram air system 112 can be disposed within the aircraft 100. For example, the ram air system 112 can be disposed within the wing-to-body fairing 110 of the aircraft 100.

Further, the disclosure comprises examples according to the following clauses:

Clause 1. A ram air system, comprising:

a ram air inlet;

a ram air outlet;

a conduit fluidly coupling the ram air inlet to the ram air outlet; and

a relief port disposed within the conduit.

Clause 2. The ram air system of Clause 1, further comprising a modulator proximate to the ram air outlet.

Clause 3. The ram air system of Clause 2, devoid of an additional modulator.

Clause 4. The ram air system of any of Clauses 1-3, further comprising an environmental control system (ECS) disposed within the conduit between the ram air inlet and the ram air outlet.

Clause 5. The ram air system of Clause 4, wherein the relief port is disposed within the conduit between the ram air inlet and the ECS.

Clause 6. The ram air system of any of Clauses 1-5, wherein the relief port comprises a valve.

Clause 7. The ram air system of any of Clauses 1-6, wherein the ram air system is disposed within an aircraft.

Clause 8. The ram air system of Clause 7, wherein the ram air system is disposed within a wing-to-body fairing of the aircraft.

Clause 9. The ram air system of any of Clauses 1-8, wherein the relief port comprises:

an air inlet formed in the conduit; and

a duct in fluid communication with the air inlet, wherein the duct comprises an air outlet.

Clause 10. The ram air system of any of Clauses 1-9, wherein the relief port is closer to the ram air inlet than the ram air outlet.

Clause 11. The ram air system of any of Clauses 1-10, wherein the relief port has a first span, and the ram air inlet has a second span, and wherein the first span is 5% or less than the second span.

Clause 12. A method of controlling a ram air system, the method comprising:

disposing a relief port within a conduit of the ram air system, wherein the conduit fluidly couples a ram air inlet to a ram air outlet.

Clause 13. The method of Clause 12, further comprising disposing a modulator proximate to the ram air outlet, wherein the ram air system is devoid of an additional modulator.

Clause 14. The method of Clauses 12 or 13, further comprising disposing an environmental control system (ECS) within the conduit between the ram air inlet and the ram air outlet.

Clause 15. The method of any of Clause 14, wherein said disposing the relief port comprises disposing the relief port within the conduit between the ram air inlet and the ECS.

Clause 16. The method of any of Clauses 12-15, further comprising disposing a valve within the relief port, wherein the valve is configured to open based on one or more of altitude, speed, position of a modulator, or measured airflow.

Clause 17. The method of any of Clauses 12-16, wherein the relief port comprises:

an air inlet formed in the conduit; and

a duct in fluid communication with the air inlet, wherein the duct comprises an air outlet.

Clause 18. The method of any of Clauses 12-17, wherein the relief port is closer to the ram air inlet than the ram air outlet.

Clause 19. An aircraft comprising:

a wing-to-body fairing; and

a ram air system including an environmental control system (ECS) within the wing-to-body fairing, wherein the ram air system comprises:
a ram air inlet;
a ram air outlet;
a conduit fluidly coupling the ram air inlet to the ram air outlet, wherein the ECS is disposed within the conduit between the ram air inlet and the ram air outlet;
a relief port disposed within the conduit, wherein the relief port is disposed within the conduit between the ram air inlet and the ECS; and
a modulator proximate to the ram air outlet, wherein the ram air system is devoid of an additional modulator.

Clause 20. The aircraft of Clause 19, wherein the relief port comprises a valve.

As described herein, examples of the present disclosure provide systems and methods for controlling resonant energy within a ram air system. Further, examples of the present disclosure provide efficient and effective systems and methods for controlling a ram air system. Additionally, examples of the present disclosure provide simpler and less costly systems and methods for controlling resonant energy within a ram air system.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A ram air system, comprising:
a ram air inlet;
a ram air outlet;
a conduit fluidly coupling the ram air inlet to the ram air outlet; and
a relief port disposed within the conduit.

2. The ram air system of claim 1, further comprising a modulator proximate to the ram air outlet.

3. The ram air system of claim 2, devoid of an additional modulator.

4. The ram air system of claim 1, further comprising an environmental control system (ECS) disposed within the conduit between the ram air inlet and the ram air outlet.

5. The ram air system of claim 4, wherein the relief port is disposed within the conduit between the ram air inlet and the ECS.

6. The ram air system of claim 1, wherein the relief port comprises a valve.

7. The ram air system of claim 1, wherein the ram air system is disposed within an aircraft.

8. The ram air system of claim 7, wherein the ram air system is disposed within a wing-to-body fairing of the aircraft.

9. The ram air system of claim 1, wherein the relief port comprises:
an air inlet formed in the conduit; and
a duct in fluid communication with the air inlet, wherein the duct comprises an air outlet.

10. The ram air system of claim 1, wherein the relief port is closer to the ram air inlet than the ram air outlet.

11. The ram air system of claim 1, wherein the relief port has a first span, and the ram air inlet has a second span, and wherein the first span is 5% or less than the second span.

12. A method of controlling a ram air system, the method comprising:
disposing a relief port within a conduit of the ram air system, wherein the conduit fluidly couples a ram air inlet to a ram air outlet.

13. The method of claim 12, further comprising disposing a modulator proximate to the ram air outlet, wherein the ram air system is devoid of an additional modulator.

14. The method of claim 12, further comprising disposing an environmental control system (ECS) within the conduit between the ram air inlet and the ram air outlet.

15. The method of claim 14, wherein said disposing the relief port comprises disposing the relief port within the conduit between the ram air inlet and the ECS.

16. The method of claim 12, further comprising disposing a valve within the relief port, wherein the valve is configured to open based on one or more of altitude, speed, position of a modulator, or measured airflow.

17. The method of claim 12, wherein the relief port comprises:
an air inlet formed in the conduit; and
a duct in fluid communication with the air inlet, wherein the duct comprises an air outlet.

18. The method of claim 12, wherein the relief port is closer to the ram air inlet than the ram air outlet.

19. An aircraft comprising:
a wing-to-body fairing; and
a ram air system including an environmental control system (ECS) within the wing-to-body fairing, wherein the ram air system comprises:
a ram air inlet;
a ram air outlet;
a conduit fluidly coupling the ram air inlet to the ram air outlet, wherein the ECS is disposed within the conduit between the ram air inlet and the ram air outlet;
a relief port disposed within the conduit, wherein the relief port is disposed within the conduit between the ram air inlet and the ECS; and
a modulator proximate to the ram air outlet, wherein the ram air system is devoid of an additional modulator.

20. The aircraft of claim 19, wherein the relief port comprises a valve.
